(19) United States
(12) Patent Application Publication
(10) Pub. No.: US 2009/0070493 A1
(43) Pub. Date: Mar. 12, 2009

(54) Interconnect component and device configuration generation

(75) Inventors: Peter Andrew Riocreux, Cheadle (GB); Andrew Mark Nightingale, Sawston (GB)

Correspondence Address: NIXON & VANDERHYE P.C., 901 N. Glebe Road, 11th Floor, Arlington, VA, 22203-1808, US

(73) Assignee: ARM LIMITED, Cambridge (GB)

(21) Appl. No.: 12/222,449

(22) Filed: Aug. 8, 2008

(30) Foreign Application Priority Data
Sep. 10, 2007 (GB) 0717607.6

(51) Int. Cl. G06F 3/00

(52) U.S. Cl. 710/16

(57) ABSTRACT

A method of generating a configuration of an integrated circuit 2 having an interconnect component 14 connecting a plurality of devices 4, 6, 8, 10, 12 uses selecting a device to be connected to the interconnect component, reading interface parameters of that device from a file or model (e.g. IP-XACT), selecting parameters of an interface “if” of the interconnect component to match the read parameters, detecting and making any settings in the configuration of the interconnect component 14 itself required to match the selected parameters of the interface and then detecting any changes required in the configuration of any devices previously connected to the interconnect component required to match the configuration of the interconnect component as it now stands. In this way, configuration of the interconnect component can be at least semi-automated with a reduction in the possibility of errors and an increase in the speed of such configuration.

### BACKGROUND OF THE INVENTION

1. Field of the Invention

This invention relates to integrated circuits. More particularly, this invention relates to the generation of a configuration for an interconnect component and devices within an integrated circuit.

2. Description of the Prior Art

It is known within the field of integrated circuits to provide an interconnect component which serves to link a plurality of functional units (devices/components) so that they can communicate and operate together. This type of arrangement is becoming increasingly important in the design of system-on-chip integrated circuits where a large number of devices are provided together upon a single integrated circuit and must be connected together so as to operate in the desired manner. The devices which are connected in this way are often pre-existing designs, such as microprocessors, memories, peripheral devices and the like. These different devices require a diversity in the interfaces between the devices and the interconnect component.

One known form of interconnect component is the ARM PL301 interconnect provided by ARM Limited of Cambridge, England. The configuration of such an interconnect is a complex and potentially error prone task. The ARM PL301 interconnect, for example, has over 2500 parameters which require setting and many of these parameters interact with each other in some way. As an example, the different devices may be capable of operating at different speeds and with different interface parameters. Higher performance may be achieved with some of these settings compared to others and it will be required that the settings used are compatible with the other devices within the integrated circuit. Selecting compatible parameters for the devices and the interconnect whilst maintaining the compatibility with all of the devices is a time consuming and difficult task.

Another trend within integrated circuit design is the trend towards design reuse. Portions of an integrated circuit or devices to be used within a system-on-chip integrated circuit represent a considerable investment in time and effort. It is desirable where possible that this effort and investment should be reused within other integrated circuits. In order to facilitate this reuse there has been developed a standard for the formal characterisation of such devices or portions of an integrated circuit and this is known as the SPIRIT/IP-XACT standard.

### SUMMARY OF THE INVENTION

Viewed from one aspect the present invention provides a method of generating a configuration of an integrated circuit having an interconnect component connected a plurality of devices, said method comprising the steps of:

(i) selecting a device to be connected to said interconnect component;

(ii) reading interface parameters of said device;

(iii) selecting parameters of an interface of said interconnect component with said device to match interface characteristics of said device specified by said interface parameters;

(iv) detecting and making any settings in a configuration of said interconnected component required to match said selected parameters of said interface; and

(v) detecting and making any changes in a configuration of a device previously connected to said interconnected component required to match said configuration of said interconnect component.

The present invention provides a technique whereby the configuration of an integrated circuit including an interconnect component and a plurality of devices may be more readily and methodically achieved thereby reducing the likelihood of error and reducing the cost of such activity. The present technique recognises that when connecting a device to an interconnect component the interface parameters of that new device can be used to select parameters of the interconnect component to match the new device being connected. Furthermore, when the interconnect component has been configured by the newly attached device the technique recognises that it is also possible to detect if any changes are required in the configuration of a device previously connected to the interconnect component so as to match the new configuration of that interconnect component. Thus, the flow of control or influence across the interface between the devices and the interconnect component not only flows from the device to the interconnect component when a new device is connected, but also from the interconnect component across to a previously connected device in order to make changes in the configuration of that previously connected device where appropriate. The configuration of the integrated circuit including the plurality of devices and the interconnect component can thus be performed in an at least semi-automated fashion with self-checking thereby reducing the likelihood of error and increasing the speed with which such operations can be performed.

Viewed from another aspect the present technique further provides the steps of:

(vi) detecting if a change is made in step (v) to a configuration of a device previously connected to said interconnected component requires a consequential change in said configuration of said interconnect component;

(vii) making any said consequential change in said configuration of said interconnect component; and

(viii) repeating steps (v), (vi) and (vii) until no further changes are required or an incompatibility is detected.

It will be appreciated that the techniques described above can be iterative in the sense that when a new device is connected to the interconnect component the consequential changes to the interconnect component and previously connected devices can propagate around the system as a whole until a mutually self-consistent configuration for the integrated circuit is achieved.

The present techniques can also be used to detect any incompatibility between a newly connected device and the interconnect component that cannot be resolved by a change in the configuration of the interconnect component. The early recognition of such incompatibilities is strongly desirable.

The techniques outlined above can be applied when each of a plurality of different devices are connected to the interconnect component. This need not necessarily correspond to all the devices to be connected to the interconnect component, but in many designs the technique will be used for all of the devices to be connected to the interconnect component.

The different devices which can be connected to the interconnect component can take a wide variety of different forms. In some embodiments these include at least one device that initiates communication and at least one device that responds to communication (e.g. master-slave arrangements).

The interface parameters associated with the devices and the interconnect component can have a wide variety of different forms. In some embodiments there can be associated default parameter values defining default interface characteristics of the devices to be used. The default parameter values may be fixed default parameter values with default parameter values that are determined dynamically in dependence upon detected configurations of at least one of the interconnect component and the plurality of other devices already connected to the interconnect component.

In order to enhance the design flexibility provided to the user of the techniques outlined above, at least one of the parameters among the interface characteristics, the configuration of the interface component and the configuration of the plurality of devices may be a user selectable parameter.

A user may be presented with a range of options that are selectable by the user with that range of options being determined in dependence upon other parameters already set for the other elements within the integrated circuit.

When a user selectable parameter is set the techniques of propagating the consequences of that setting around the different elements of the integrated circuit may be performed with the changes and influences propagating in either direction across the interfaces between the interconnect component and the devices until a self-consistent configuration of the integrated circuit as a whole is achieved or incompatibility is detected.

It will be appreciated that the configurations of the interconnect component and the devices which may be set can take a wide variety of different forms. These forms include a transaction identifier width, a data width, an address space associated with a device, a bandwidth requirement, a registration status of ports of a device, a clock speed, a maximum clock speed, a constraint upon one or more characteristics set during synthesis of the integrated circuit and a matching test data set to be used in testing the integrated circuits manufactured in accordance with that design. It will be appreciated that many additional and/or alternative configuration parameters may be controlled using the techniques described herein.

A further refinement which may optionally be provided is to detect if an alternative device for a device being connected to the interconnect component is available and would provide an improvement in one or more characteristics of the integrated circuit and then to notify a user of the alternative device. As an example, a user may be attempting to connect an out-of-date design of memory to an interconnect component being used within an integrated circuit when it is known that a more suitable memory is available that would improve the performance of the integrated circuit concerned and better match the other devices or components within that integrated circuit. The user may be notified of the existence of such an alternative device in order that they may consider its use instead of the initially intended device.

The outline form of the integrated circuit to be produced can be set out in advance in received user input defining at least the plurality of devices which are to be connected to the interconnect component and communication paths which are to exist between the plurality of devices. This high-level design information can be used to guide the configuration selections being made for the devices and the interconnect component so as to target the communication paths which are desired and with an awareness of the devices which are to be attached. Such high level design information can be provided by the integrated circuit designer who will generally know what are intended to be the main communication paths between the devices concerned and accordingly can provide this information in order that the interconnect component is configured to match these requirements.

As an example of further user input which can define characteristics of the system known to the designer, the user can define the relative arbitration priority levels of the devices which are to be connected. Again the system designer will generally already have a good idea of which arbitration priority levels should be assigned due to their knowledge of the intended use of the integrated circuit being designed and the likely important communication paths which should be given priority.

Viewed from another aspect the present invention provides a computer program storage medium storing a computer program for controlling a computer to perform a method of generating a configuration of an integrated circuit having an interconnect component connected a plurality of devices, said method comprising the steps of:

(i) selecting a device to be connected to said interconnect component;

(ii) reading interface parameters of said device;

(iii) selecting parameters of an interface of said interconnect component with said device to match interface characteristics of said device specified by said interface parameters;

(iv) detecting and making any settings in a configuration of said interconnected component required to match said selected parameters of said interface; and

(v) detecting and making any changes in a configuration of a device previously connected to said interconnected component required to match said configuration of said interconnect component.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates an integrated circuit including a plurality of devices and interconnect component;

FIG. 2 schematically illustrates a small selection of possible signals passed across an interface between a device and interconnect component;

FIG. 3 is a flow diagram schematically illustrating steps performed when connecting components/devices to an interconnect component in accordance with the present techniques;

FIG. 4 is a flow diagram schematically illustrating the calculation of ID widths within an integrated circuit;

FIG. 5 is a flow diagram schematically illustrating the configuration of clock domain crossings within an integrated circuit; and

FIG. 6 is a flow diagram schematically illustrating the choosing of cyclic dependency avoidance schemes to be used within an integrated circuit.

### DESCRIPTION OF THE PREFERRED EMBODIMENTS

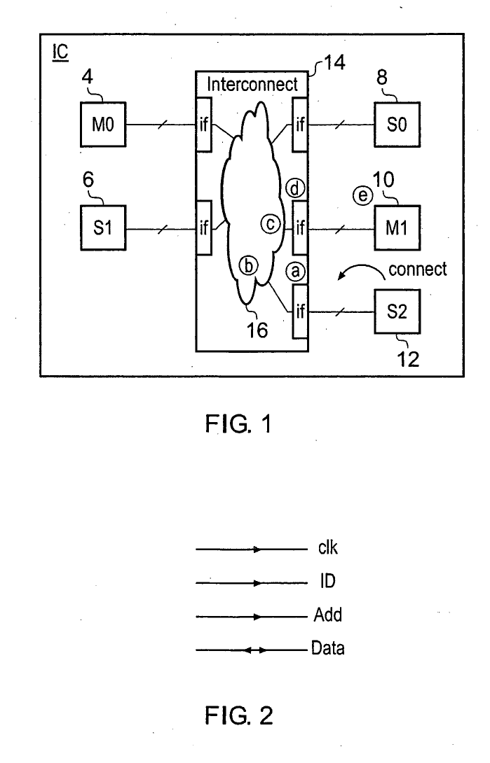

FIG. 1 illustrates an integrated circuit 2 composed of a plurality of devices 4, 6, 8, 10, 12 connected via respective interfaces “if” to an interconnect component 14. The devices 4, 6, 8, 10, 12 can include master devices 4, 10 and slave devices 6, 8, 12. Master devices 4, 10 initiate communication and slave devices 6, 8, 12 respond to communication. An individual device 4, 6, 8, 10, 12 may in some circumstances serve as both a master device and a slave device depending upon the circumstances.

The interconnect component 14 is used to provide desired communication paths between the devices 4, 6, 8, 10, 12 so as together form the system-on-chip integrated circuit 2. The interconnect component 14 may have the form of the known ARM PL301 interconnect previously discussed. The interfaces “if” between the respective devices 4, 6, 8, 10, 12 and the interconnect component 14 have configuration parameters associated therewith. The interconnect component 14 also has configuration parameters as do the individual devices 4, 6, 8, 10, 12. All of these parameters require setting in order for the design of the integrated circuit 2 to be settled in a form suitable for synthesis and production. The setting of what can be a very large number of potentially interrelated parameters within the integrated circuit 2 is a time consuming and potentially error prone process when performed by a user.

A user will typically already know the main communication paths which it is desired to provide between the various devices 4, 6, 8, 10, 12 via the interconnect component 14. As an example, the system designer may at the outset know that master device 4 requires the ability to communicate with all of the slave devices 6, 8, and 12, whereas the master device 10 only requires the ability to communicate with the slave device 6 and 8, but does not require the ability to communicate with the slave device 12. The interconnect component 14 provides the appropriate multiplexers, buses and arbitration circuitry to support such a communication topology. This type of consideration and communication support is known within interconnect components such as the ARM PL301 and will be familiar to those skilled within this technical field.

As is illustrated in FIG. 1, it is desired to connect a new device 12 to the interconnect component 14 when the devices 4, 6, 8, 10 have already been connected to the interconnect component 14. Thus, as the device 12 is connected, a parameter file (e.g. an IP-XACT file) associated with the device 12 is read in order that the parameters characterising its interface with the interconnect 14 can be read and used to configure that interface as is illustrated by step “a” shown in FIG. 1. The configuration of the interface at step “a” in turn has a knock-on effect on the configuration of the multiplexing, bussing, arbitration and other circuitry 16 within the interconnect component 14 as is illustrated in step “b”. This change propagates through the design and the configuration of all of the other previously connected devices 4, 6, 8, 10 are checked to determine that they are appropriate with the newly set parameters that have been set or constrained by the connection of the new device 12. In the example illustrated, the configuration of the interconnect component 14 as associated with the connection circuitry and interface with the device 10 are influenced and changed at steps “c” and “d”. The change in the configuration of the interface at step “d” also has a knock on effect and requires a change in the configuration of the previously connected device 10 as illustrated at step “e”. Thus, it will be seen that changes in the configuration and control of such changes pass both from the devices 4, 6, 8, 10, 12 to the interconnect component 14 and from the interconnect component 14 to the devices 4, 6, 8, 10, 12. The changes are propagated throughout the configuration parameters of the system as a whole until a stable mutually self-consistent configuration is arrived at or an incompatibility is detected. A detected incompatibility can be flagged to the user. In some cases a user settable parameter may be altered in order to resolve the incompatibility or some change can be made in the underlying communication topology or other predefined characteristics in order to resolve the problem. The user can predefine arbitration priorities associated with the different devices 4, 6, 8, 10, 12 that are used by the arbitration circuits provided within the interconnect component 14 to regulate the flow of communication.

FIG. 2 schematically illustrates an example of the type of signals which can be passed between a device 4, 6, 8, 10, 12 and an interconnect component 14. These include a clock signal clk, which can have a clock speed associated with it and a maximum clock speed; a transaction identifier ID, which can have a transaction identifier width associated with it, and address and data signals which can have respective widths associated therewith. It will be appreciated that other parameters of the interface signals concerned can include an address space to be associated with the device connected via that interface; the registration status of ports of the device to be connected; constraints upon one or more characteristics which are to be set during synthesis of the device; and a matching test data set to be used to test the device concerned either in its design form or in its manufactured form. It will be appreciated that many other parameters may be associated with the interface signals being passed between the devices, the devices themselves and the interconnect component 14 providing the communication paths between the devices.

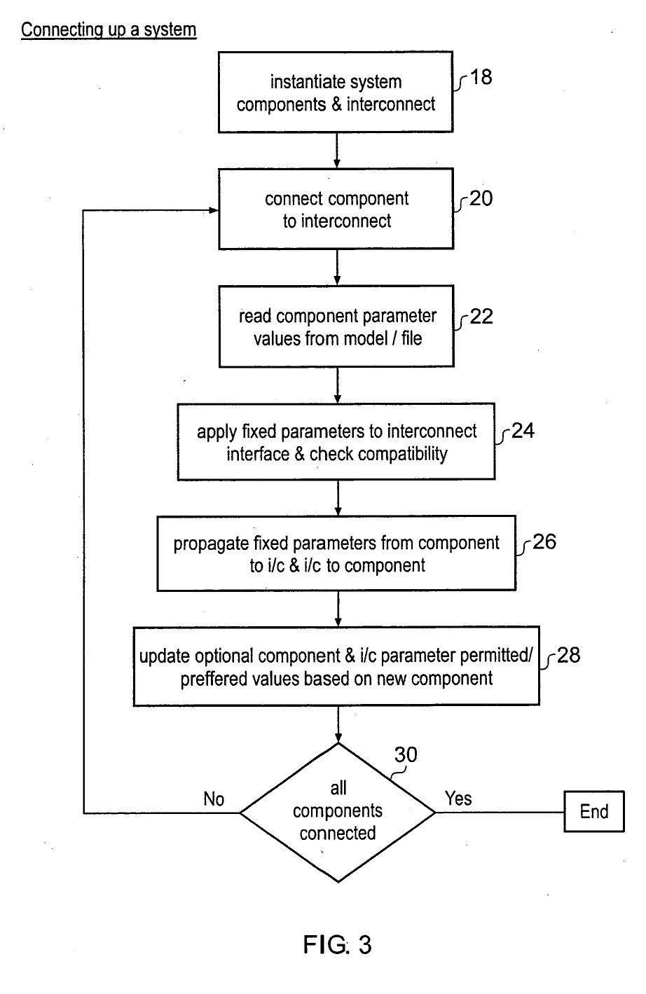

FIG. 3 is a flow diagram schematically illustrating the connection of devices 4, 6, 8, 10, 12 to an interconnect component. At step 18 the system is instantiated and the components to be connected are selected. At the same time a user defines the communication path topology which is to be provided by the interconnect being instantiated together with other high level design parameters such as the arbitration priorities to be used.

At step 20 the first device to be connected to the interconnect component 14 and to have its configuration set is selected. At step 22 the parameter values for that device are read from a model or file characterising that device. At step 24 the fixed parameters specified within the model or file are applied both to the device concerned and the interconnect component interface for that device and the compatibility of those fixed parameters checked against the existing configuration of the interconnect device. User selectable parameters may also be set at the same time with the user being prompted to select these parameters either freely or from a list of options dynamically determined in dependence upon constraints imposed by other existing parameters or configurations of the system which have already been established. If an incompatibility is detected which is not resolvable by an allowed change in a configuration parameter, then this can be flagged to the user. Furthermore, if an alternative device to the device being connected is indicated as being available within a library of available devices and such a device could improve performance or other characteristics of the system, then this can be flagged to the user so that they can change the device they are connected if appropriate.

At step 26 the parameters set for the interface with the newly connected device are propagated through the interconnect component 14 to influence where necessary other parameters already set within the interconnect component 14 as well as to other devices already connected to the interconnect component 14 in order that compatibility between the parameters of the system as a whole can be checked and any necessary identified changes made or fundamental incompatibilities flagged. At step 28 any changes necessary within optional component or interconnect parameters may be flagged to the user such that the user can select a new compatible parameter from the range of permitted or preferred parameter values which are optionally selectable for that configuration parameter. As an example, a user may have previously selected a desired clock frequency for a particular device from among a range of potential clock frequencies but the connection of a new device may have made that particular individual previous clock frequency selection inappropriate and accordingly the user can be prompted to make a new selection from what are the permitted clock frequencies given the new configuration of the system as a whole.

At step 30 a determination is made as to whether all of the components/devices have yet been connected to the interconnect component 14. If some devices remain to be connected, then the next of these is selected and processing is returned to step 20. Otherwise the configuration of the interconnect component 14 and the devices 4, 6, 8, 10, 12 is complete and processing terminates.

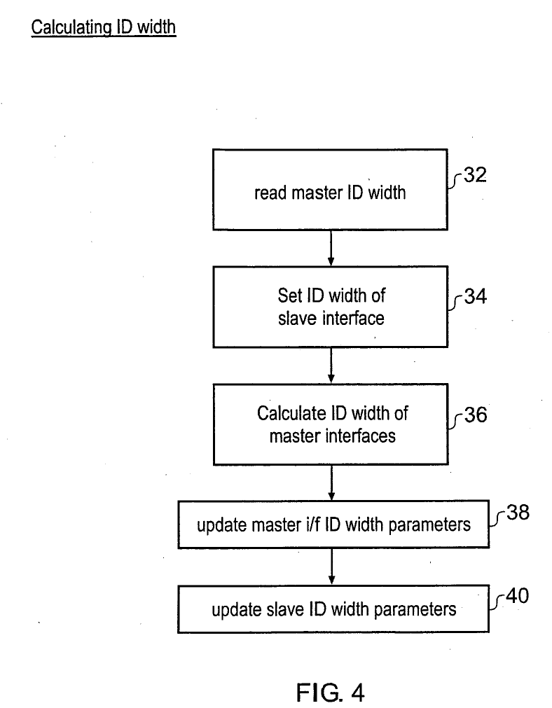

FIG. 4 is a flow diagram schematically illustrating the calculation of a transaction identifier width to be used for a communication path between a master device and a slave device. At step 32 the master device transaction identifier width is read as a parameter associated with a model or a file for that master device. At step 34 the transaction identifier width of the slave interface to connect with that master device is set. Step 36 then calculates the transaction identifier widths for the master interfaces of the interconnect component which are to be used to communicate the transactions concerned to respective slave devices. Step 38 updates any of these master interface transaction identifier widths as necessary to support and be compatible with the new master device that has been connected. Step 40 then updates the slave transaction identifier width parameters within the slave devices which are to be connected to the master interfaces of the interconnect component as set out at step 38. Thus, a requirement or constraint in the transaction identifier width as set by a newly connecting master device propagates through the design with any necessary changes in the transaction identifier width being made in the interconnect component interfaces and the slave devices or other devices as appropriate.

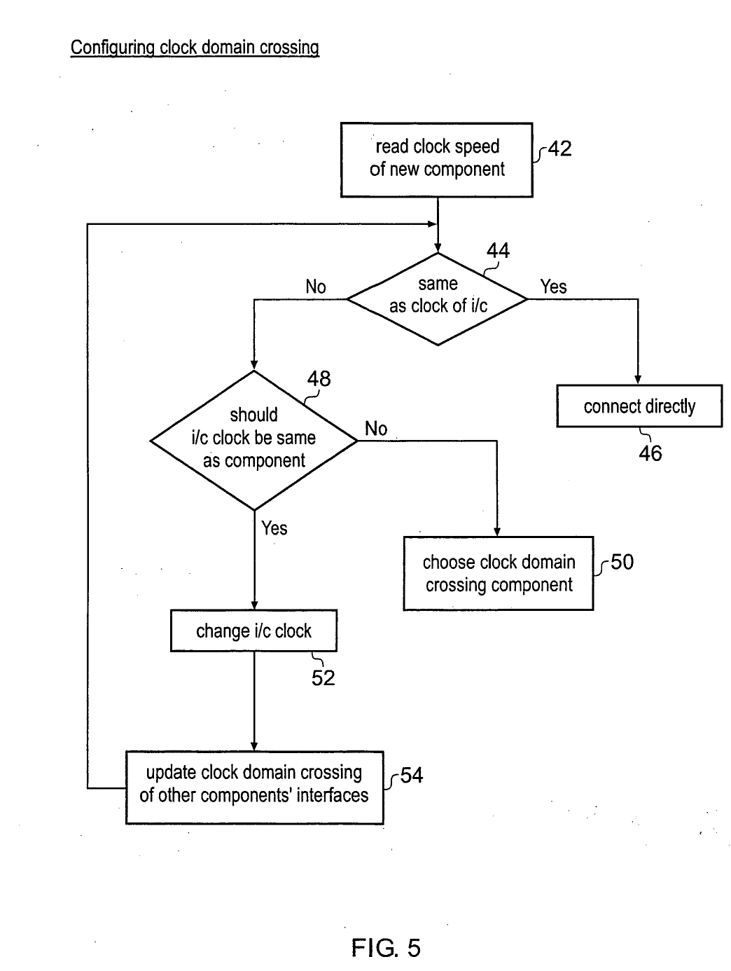

FIG. 5 is a flow diagram schematically illustrating the configuration of clock domain crossing parameters. At step 42 the clock speed of a new component to be connected is read. Step 44 determines if this is the same as the clock speed of the interconnect component 14 as already configured. If there is a match, then step 46 directly connects the new component/device to the interconnect component. If there is not a match, then step 48 determines whether the interconnect component clock speed should be adjusted to be the same as the newly connecting device. If this is either not appropriate or not possible, then step 50 selects the clock interface between the newly connecting component and the interconnect component as a clock domain crossing point and an appropriate circuit block will be added within the interconnect component to support such clock domain crossing.

If the determination at step 48 was that the interconnect component should have its clock frequency changed, then this is done at step 52 and appropriate changes in the clock speeds and/or necessary clock domain crossing components are added in order to support the already connected devices within the system at step 54. If a device has its clock speed changed from that which was set when it was previously connected then it is treated as a newly connecting device for the purpose of checking clock compatibility and any requirement for clock domain crossing components with processing being returned to step 44.

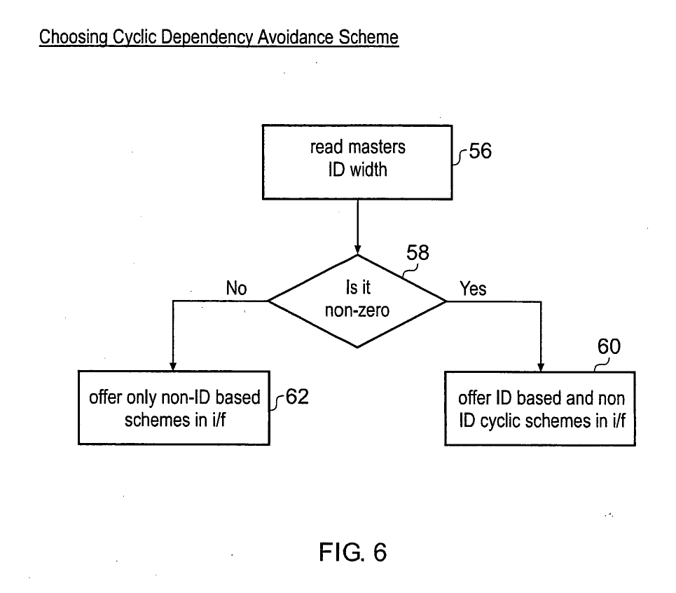

FIG. 6 is a flow diagram schematically illustrating the selection of a cyclic dependence avoidance scheme. At step 56 the master transaction identifier width determined for a newly connecting master device. Step 58 determines whether or not this transaction identifier width is non-zero. If the width is non-zero, then step 60 offers a selection of transaction identifier based and non-transaction identifier based cyclic dependency avoidance schemes for selection by the user. If the determination at step 58 was that the transaction identifier width associated with the newly connected device is 0 then processing proceeds to step 62 at which transaction identifier based cyclic dependency avoidance schemes are offered to the user.

If the user or system were to charge the transaction identifier width from zero to non-zero, then the process illustrated in FIG. 6 would offer additional configuration options (to possibly be select by the user). Conversely, charging from non-zero to zero transaction identifier width results in a reduction in the number of options available, and an option already selected may become invalid (and possibly automatically changed or flagged).

Although illustrative embodiments of the invention have been described in detail herein with reference to the accompanying drawings: it is to be understood that the invention is not limited to those precise embodiments, and that various changes and modifications can be effected therein by one skilled in the art without departing from the scope and spirit of the invention as defined by the appended claims.

We claim:

1. A method of generating a configuration of an integrated circuit having an interconnect component connecting a plurality of devices, said method comprising the steps of:
(i) selecting a device to be connected to said interconnect component;
(ii) reading interface parameters of said device;
(iii) selecting parameters of an interface of said interconnect component with said device to match interface characteristics of said device specified by said interface parameters;
(iv) detecting and making any settings in a configuration of said interconnected component required to match said selected parameters of said interface; and
(v) detecting and making any changes in a configuration of a device previously connected to said interconnected component required to match said configuration of said interconnect component.

2. A method as claimed in claim 1, further comprising the steps of:
(vi) detecting if a change is made in step (v) to a configuration of a device previously connected to said interconnected component requires a consequential change in said configuration of said interconnect component;
(vii) making any said consequential change in said configuration of said interconnect component; and
(viii) repeating steps (v), (vi) and (vii) until no further changes are required or an incompatibility is detected.

3. A method as claimed in claim 1, further comprising, when a device is connected to said interconnect component, the step of detecting any incompatibility between said device and said interconnect component that cannot be resolved by a change in said configuration of said interconnect component.

4. A method as claimed in claim 1, wherein said steps (i) to (v) are repeated for each of a plurality of devices to be connected to said interconnect component.

5. A method as claimed in claim 4, wherein said steps (i) to (v) are repeated for all devices to be connected to said interconnect component.

6. A method as claimed in claim 1, wherein said plurality of devices include at least one device that initiates communication and at least one device that responds to communication.

7. A method as claimed in claim 1, wherein said interface parameters have associated default parameter values defining default interface characteristics of said device.

8. A method as claimed in claim 7, wherein said associated default parameter values are one of predetermined fixed default parameter values or default parameter values determined dynamically in dependence upon detected said configurations of at least one of said interconnect component and said plurality of devices.

9. A method as claimed in claim 1, wherein at least one parameter among said interface characteristics, said configuration of said interface component and said configurations of said plurality of devices is a user selectable parameter.

10. A method as claimed in claim 9, wherein a range of options selectable as a user selectable interface characteristic is determined in dependence upon at least one other parameter among said interface characteristics, said configuration of said interface component and said configurations of said plurality of devices

11. A method as claimed in claim 2, wherein at least one parameter among said interface characteristics, said configuration of said interface component and said configurations of said plurality of devices is a user selectable parameter; and
further comprising, when a user selectable parameter is set, the steps of:
(ix) detecting if said user selectable parameter requires a consequential setting in any of said configuration of said interconnect component and said configurations of said plurality of devices or is incompatible therewith;
(x) making said consequential setting; and
(xi) repeating steps (v), (vi) and (vii) until no further changes are required or an incompatibility is detected.

12. A method as claimed in claim 1, wherein at least one of said configuration of said interconnect component and said configurations of said devices comprises one or more of:
a transaction identifier width;
a data width;
an address space associated with said device;
a bandwidth requirement;
registration status of ports of said device;
clock speed;
maximum clock speed;
a constraint upon one or more characteristics set during synthesis; and
a matching test data set.

13. A method as claimed in claim 1, further comprising the steps of:
detecting if an alternative device for a device being connected to said interconnect component is available and would provide a difference in one or more characteristics of said integrated circuit; and
notifying a user of said alternative device.

14. A method as claimed in claim 1, further comprising the step of receiving user input defining at least said plurality of devices to be connected to said interconnect component and communication paths between said plurality of devices.

15. A method as claimed in claim 14, wherein said user input further defines relative arbitration priority levels of said plurality of devices.

16. A computer program storage medium storing a computer program for controlling a computer to perform a method of generating a configuration of an integrated circuit having an interconnect component connecting a plurality of devices, said method comprising the steps of:
(i) selecting a device to be connected to said interconnect component;
(ii) reading interface parameters of said device;
(iii) selecting parameters of an interface of said interconnect component with said device to match interface characteristics of said device specified by said interface parameters;
(iv) detecting and making any settings in a configuration of said interconnected component required to match said selected parameters of said interface; and
(v) detecting and making any changes in a configuration of a device previously connected to said interconnected component required to match said configuration of said interconnect component.

17. A computer program product as claimed in claim 16, wherein said method further comprises the steps of:
(vi) detecting if a change is made in step (v) to a configuration of a device previously connected to said interconnected component requires a consequential change in said configuration of said interconnect component;
(vii) making any said consequential change in said configuration of said interconnect component; and
(viii) repeating steps (v), (vi) and (vii) until no further changes are required or an incompatibility is detected.

18. A computer program product as claimed in claim 16, wherein said method further comprises, when a device is connected to said interconnect component, the step of detecting any incompatibility between said device and said interconnect component that cannot be resolved by a change in said configuration of said interconnect component.

19. A computer program product as claimed in claim 16, wherein said steps (i) to (v) are repeated for each of a plurality of devices to be connected to said interconnect component.

20. A computer program product as claimed in claim 19, wherein said steps (i) to (v) are repeated for all devices to be connected to said interconnect component.

21. A method as claimed in claim 16, wherein said plurality of devices include at least one device that initiates communication and at least one device that responds to communication.

22. A computer program product as claimed in claim 16, wherein said interface parameters have associated default parameter values defining default interface characteristics of said device.

23. A computer program product as claimed in claim 22, wherein said associated default parameter values are one of predetermined fixed default parameter values or default parameter values determined dynamically in dependence upon detected said configurations of at least one of said interconnect component and said plurality of devices.

24. A computer program product as claimed in claim 16, wherein at least one parameter among said interface characteristics, said configuration of said interface component and said configurations of said plurality of devices is a user selectable parameter.

25. A computer program product as claimed in claim 24, wherein a range of options selectable as a user selectable interface characteristic is determined in dependence upon at least one other parameter among said interface characteristics, said configuration of said interface component and said configurations of said plurality of devices

26. A computer program product as claimed in claim 17, wherein at least one parameter among said interface characteristics, said configuration of said interface component and said configurations of said plurality of devices is a user selectable parameter; and
said method further comprises, when a user selectable parameter is set, the steps of:
(ix) detecting if said user selectable parameter requires a consequential setting in any of said configuration of said interconnect component and said configurations of said plurality of devices or is incompatible therewith;
(x) making said consequential setting; and
(xi) repeating steps (v), (vi) and (vii) until no further changes are required or an incompatibility is detected.

27. A computer program product as claimed in claim 16, wherein at least one of said configuration of said interconnect component and said configurations of said devices comprises one or more of:
a transaction identifier width;
a data width;
an address space associated with said device;
a bandwidth requirement;
registration status of ports of said device;
clock speed;
maximum clock speed;
a constraint upon one or more characteristics set during synthesis; and
a matching test data set.

28. A computer program product as claimed in claim 16, wherein said method further comprises the steps of:
detecting if an alternative device for a device being connected to said interconnect component is available and would provide an improvement in one or more characteristics of said integrated circuit; and
notifying a user of said alternative device.

29. A computer program product as claimed in claim 16, wherein said method further comprises the step of receiving user input defining at least said plurality of devices to be connected to said interconnect component and communication paths between said plurality of devices.

30. A computer program product as claimed in claim 29, wherein said user input further defines relative arbitration priority levels of said plurality of devices.
